(19) United States
(12) Patent Application Publication
(10) Pub. No.: US 2020/0180754 A1
(43) Pub. Date: Jun. 11, 2020

(54) FLYING TAXI FOR FACILITATING THE TRANSPORTATION OF PAYLOADS

(71) Applicant: William David Schonfelder, Killeen, TX (US)

(72) Inventor: William David Schonfelder, Killeen, TX (US)

(73) Assignees: Dennis bragg, Chantilly, VA (US); Shelia Bragg, Chantilly, VA (US)

(21) Appl. No.: 16/709,588

(22) Filed: Dec. 10, 2019

Related U.S. Application Data
(60) Provisional application No. 62/778,261, filed on Dec. 11, 2018.
(60) Provisional application No. 62/778,613, filed on Dec. 12, 2018.

(51) Int. Cl. B64C 27/22; B64C 19/00; B64D 45/00; G01G 19/08

(52) U.S. Cl. CPC B64C 27/22; G01G 19/08; B64D 45/00; B64C 19/00

(57) ABSTRACT

Disclosed herein is a flying taxi for facilitating the transportation of payloads, in accordance with some embodiments. Accordingly, the flying taxi may include a pod, a processing device, a presentation device, and an aerial vehicle. Further, the pod may be configured to receive a payload. Further, the pod may include a weight sensor disposed on the pod. Further, the weight sensor may be configured to generate a weight data corresponding to a weight of the payload. Further, the processing device may be communicatively coupled with the weight sensor. Further, the processing device may be configured for analyzing the weight data. Further, the processing device may be configured for generating a notification based on the analyzing. Further, the presentation device may be communicatively coupled with the processing device. Further, the aerial vehicle may be detachably couplable with the pod using a coupling mechanism.

### RELATED APPLICATION(S)

Under provisions of 35 U.S.C. § 119e, the Applicant(s) claim the benefit of U.S. provisional application No. 62/778,261, filed on Dec. 11, 2018 and U.S. provisional application No. 62/778,613, filed on Dec. 12, 2018, which is incorporated herein by reference.

### TECHNICAL FIELD

Generally, the present disclosure relates to the field of aviation. More specifically, the present disclosure describes a flying taxi for facilitating the transportation of payloads.

### BACKGROUND

In the present scenario, the roads and highways are getting more and more congested. The number of cars on the roads is increasing enormously with each passing day. Further, there is an increase in pollution with the increase in cars. There are long traffic jams and road clogs daily, which are very tiring and time-wasting. This makes traveling on roads very costly, and wastage of time and energy. Further, the modes of transportation in cities are restricted to land and waterways that may consume a lot of time. Therefore, there is a need to find new modes of transportation, which save time and are more convenient.

Further, there is a need for self-driven/autonomous flying vehicles to make flying taxi services more efficient and energy-saving. Further, the flying taxis need additional security features to make the flying taxis safe and more trustworthy.

Therefore, there is a need for an improved flying taxi for facilitating the transportation of payloads that may overcome one or more of the above-mentioned problems and/or limitations.

### BRIEF SUMMARY

This summary is provided to introduce a selection of concepts in a simplified form, that are further described below in the Detailed Description. This summary is not intended to identify key features or essential features of the claimed subject matter. Nor is this summary intended to be used to limit the claimed subject matter's scope.

Disclosed herein is a flying taxi for facilitating the transportation of payloads, in accordance with some embodiments. Accordingly, the flying taxi may include at least one pod, a processing device, a presentation device, and at least one aerial vehicle. Further, the at least one pod may be configured to receive at least one payload. Further, the at least one pod may include at least one weight sensor disposed on the at least one pod. Further, the at least one payload may include at least one of passenger, cargo, etc. Further, the at least one weight sensor may be configured to generate at least one weight data corresponding to a weight of a payload of the at least one payload. Further, the processing device may be communicatively coupled with the at least one weight sensor. Further, the processing device may be configured for analyzing the at least one weight data. Further, the processing device may be configured for generating at least one notification based on the analyzing. Further, the presentation device may be communicatively coupled with the processing device. Further, the presentation device may be configured for presenting the at least one notification. Further, the at least one aerial vehicle may be detachably couplable with the at least one pod using at least one coupling mechanism. Further, the at least one aerial vehicle may include at least one propeller assembly disposed on an aerial vehicle of the at least one aerial vehicle. Further, the at least one propeller assembly may be configured for propelling the flying taxi.

Both the foregoing summary and the following detailed description provide examples and are explanatory only. Accordingly, the foregoing summary and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the applicants. The applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure.

FIG. 1 is an illustration of an online platform consistent with various embodiments of the present disclosure.

FIG. 2 is a flying taxi for facilitating the transportation of payloads, in accordance with some embodiments.

FIG. 3 is the flying taxi for facilitating the transportation of payloads, in accordance with further embodiments.

FIG. 4 is the flying taxi to facilitate transitioning of a vehicle positioning foot, in accordance with further embodiments.

FIG. 5 is a front view of the flying taxi, in accordance with exemplary embodiments.

FIG. 6 is a side view of the flying taxi, in accordance with exemplary embodiments.

FIG. 7 is a side view of the at least one pod of the flying taxi, in accordance with exemplary embodiments.

FIG. 8 is a front view of the at least one pod of the flying taxi, in accordance with exemplary embodiments.

FIG. 9 is a top view of the at least one pod of the flying taxi, in accordance with exemplary embodiments.

FIG. 10 is a top view of the at least one aerial vehicle, in accordance with exemplary embodiments.

FIG. 11 is a side view of the at least one aerial vehicle of the flying taxi, in accordance with exemplary embodiments.

FIG. 12 is a flying taxi for facilitating the transportation of payloads, in accordance with some embodiments.

FIG. 13 shows an exemplary representation of a drone taxi, in accordance with some embodiments.

FIG. 14 is an exemplary representation of the passenger pod, in accordance with some embodiments.

FIG. 15 is an exemplary representation of the drone taxi, in accordance with some embodiments.

FIG. 16 is an exemplary representation of the swarm technology implemented in a plurality of drone taxis, in accordance with some embodiments.

FIG. 17 shows a flowchart of a method to facilitate the interaction of a passenger and a service provider of a drone taxi service, in accordance with some embodiments.

FIG. 18 illustrates an inside view of the drone taxi, in accordance with some embodiments.

FIG. 19 is a block diagram of a computing device for implementing the methods disclosed herein, in accordance with some embodiments.

### DETAILED DESCRIPTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim limitation found herein and/or issuing here from that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present disclosure. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the claims found herein and/or issuing here from. The present disclosure contains headers. It should be understood that these headers are used as references and are not to be construed as limiting upon the subjected matter disclosed under the header.

The present disclosure includes many aspects and features. Moreover, while many aspects and features relate to, and are described in the context of flying taxi for facilitating the transportation of payloads, embodiments of the present disclosure are not limited to use only in this context.

In general, the method disclosed herein may be performed by one or more computing devices. For example, in some embodiments, the method may be performed by a server computer in communication with one or more client devices over a communication network such as, for example, the Internet. In some other embodiments, the method may be performed by one or more of at least one server computer, at least one client device, at least one network device, at least one sensor and at least one actuator. Examples of the one or more client devices and/or the server computer may include, a desktop computer, a laptop computer, a tablet computer, a personal digital assistant, a portable electronic device, a wearable computer, a smart phone, an Internet of Things (IoT) device, a smart electrical appliance, a video game console, a rack server, a super-computer, a mainframe computer, mini-computer, micro-computer, a storage server, an application server (e.g. a mail server, a web server, a real-time communication server, an FTP server, a virtual server, a proxy server, a DNS server etc.), a quantum computer, and so on. Further, one or more client devices and/or the server computer may be configured for executing a software application such as, for example, but not limited to, an operating system (e.g. Windows, Mac OS, Unix, Linux, Android, etc.) in order to provide a user interface (e.g. GUI, touch-screen based interface, voice based interface, gesture based interface etc.) for use by the one or more users and/or a network interface for communicating with other devices over a communication network. Accordingly, the server computer may include a processing device configured for performing data processing tasks such as, for example, but not limited to, analyzing, identifying, determining, generating, transforming, calculating, computing, compressing, decompressing, encrypting, decrypting, scrambling, splitting, merging, interpolating, extrapolating, redacting, anonymizing, encoding and decoding. Further, the server computer may include a communication device configured for communicating with one or more external devices. The one or more external devices may include, for example, but are not limited to, a client device, a third party database, public database, a private database and so on. Further, the communication device may be configured for communicating with the one or more external devices over one or more communication channels. Further, the one or more communication channels may include a wireless communication channel and/or a wired communication channel. Accordingly, the communication device may be configured for performing one or more of transmitting and receiving of information in electronic form. Further, the server computer may include a storage device configured for performing data storage and/or data retrieval operations. In general, the storage device may be configured for providing reliable storage of digital information. Accordingly, in some embodiments, the storage device may be based on technologies such as, but not limited to, data compression, data backup, data redundancy, deduplication, error correction, data finger-printing, role based access control, and so on.

Further, one or more steps of the method disclosed herein may be initiated, maintained, controlled and/or terminated based on a control input received from one or more devices operated by one or more users such as, for example, but not limited to, an end user, an admin, a service provider, a service consumer, an agent, a broker and a representative thereof. Further, the user as defined herein may refer to a human, an animal or an artificially intelligent being in any state of existence, unless stated otherwise, elsewhere in the present disclosure. Further, in some embodiments, the one or more users may be required to successfully perform authentication in order for the control input to be effective. In general, a user of the one or more users may perform authentication based on the possession of a secret human readable secret data (e.g. username, password, passphrase, PIN, secret question, secret answer etc.) and/or possession of a machine readable secret data (e.g. encryption key, decryption key, bar codes, etc.) and/or or possession of one or more embodied characteristics unique to the user (e.g. biometric variables such as, but not limited to, fingerprint, palm-print, voice characteristics, behavioral characteristics, facial features, iris pattern, heart rate variability, evoked potentials, brain waves, and so on) and/or possession of a unique device (e.g. a device with a unique physical and/or chemical and/or biological characteristic, a hardware device with a unique serial number, a network device with a unique IP/MAC address, a telephone with a unique phone number, a smartcard with an authentication token stored thereupon, etc.). Accordingly, the one or more steps of the method may include communicating (e.g. transmitting and/or receiving) with one or more sensor devices and/or one or more actuators in order to perform authentication. For example, the one or more steps may include receiving, using the communication device, the secret human readable data from an input device such as, for example, a keyboard, a keypad, a touch-screen, a microphone, a camera and so on. Likewise, the one or more steps may include receiving, using the communication device, the one or more embodied characteristics from one or more biometric sensors.

Further, one or more steps of the method may be automatically initiated, maintained and/or terminated based on one or more predefined conditions. In an instance, the one or more predefined conditions may be based on one or more contextual variables. In general, the one or more contextual variables may represent a condition relevant to the performance of the one or more steps of the method. The one or more contextual variables may include, for example, but are not limited to, location, time, identity of a user associated with a device (e.g. the server computer, a client device etc.) corresponding to the performance of the one or more steps, environmental variables (e.g. temperature, humidity, pressure, wind speed, lighting, sound, etc.) associated with a device corresponding to the performance of the one or more steps, physical state and/or physiological state and/or psychological state of the user, physical state (e.g. motion, direction of motion, orientation, speed, velocity, acceleration, trajectory, etc.) of the device corresponding to the performance of the one or more steps and/or semantic content of data associated with the one or more users. Accordingly, the one or more steps may include communicating with one or more sensors and/or one or more actuators associated with the one or more contextual variables. For example, the one or more sensors may include, but are not limited to, a timing device (e.g. a real-time clock), a location sensor (e.g. a GPS receiver, a GLONASS receiver, an indoor location sensor etc.), a biometric sensor (e.g. a fingerprint sensor), an environmental variable sensor (e.g. temperature sensor, humidity sensor, pressure sensor, etc.) and a device state sensor (e.g. a power sensor, a voltage/current sensor, a switch-state sensor, a usage sensor, etc. associated with the device corresponding to performance of the or more steps).

Further, the one or more steps of the method may be performed one or more number of times. Additionally, the one or more steps may be performed in any order other than as exemplarily disclosed herein, unless explicitly stated otherwise, elsewhere in the present disclosure. Further, two or more steps of the one or more steps may, in some embodiments, be simultaneously performed, at least in part. Further, in some embodiments, there may be one or more time gaps between performance of any two steps of the one or more steps.

Further, in some embodiments, the one or more predefined conditions may be specified by the one or more users. Accordingly, the one or more steps may include receiving, using the communication device, the one or more predefined conditions from one or more and devices operated by the one or more users. Further, the one or more predefined conditions may be stored in the storage device. Alternatively, and/or additionally, in some embodiments, the one or more predefined conditions may be automatically determined, using the processing device, based on historical data corresponding to performance of the one or more steps. For example, the historical data may be collected, using the storage device, from a plurality of instances of performance of the method. Such historical data may include performance actions (e.g. initiating, maintaining, interrupting, terminating, etc.) of the one or more steps and/or the one or more contextual variables associated therewith. Further, machine learning may be performed on the historical data in order to determine the one or more predefined conditions. For instance, machine learning on the historical data may determine a correlation between one or more contextual variables and performance of the one or more steps of the method. Accordingly, the one or more predefined conditions may be generated, using the processing device, based on the correlation.

Further, one or more steps of the method may be performed at one or more spatial locations. For instance, the method may be performed by a plurality of devices interconnected through a communication network. Accordingly, in an example, one or more steps of the method may be performed by a server computer. Similarly, one or more steps of the method may be performed by a client computer. Likewise, one or more steps of the method may be performed by an intermediate entity such as, for example, a proxy server. For instance, one or more steps of the method may be performed in a distributed fashion across the plurality of devices in order to meet one or more objectives. For example, one objective may be to provide load balancing between two or more devices. Another objective may be to restrict a location of one or more of an input data, an output data and any intermediate data there between corresponding to one or more steps of the method. For example, in a client-server environment, sensitive data corresponding to a user may not be allowed to be transmitted to the server computer. Accordingly, one or more steps of the method operating on the sensitive data and/or a derivative thereof may be performed at the client device.

### Overview

The present disclosure describes a flying taxi for facilitating the transportation of payloads. Further, the flying taxi may include a drone taxi. Further, the drone taxi may be an automated vehicle and may include a combination of a passenger pod and a drone. Further, the drone taxi may be a safe, reliable, remote piloted transportation system. Further, professional pilots may monitor takeoffs and landing of the drone taxi. Further, a passenger may avoid congested traffic and at the same time enjoy a bird's eye view of the surroundings out the windows. Further, a service provider may plot the safest route for the passenger on display. Further, the drone taxi may be controllable by one or more means of control such as through remote control from a mission center, a radio device, one or more passengers of the drone taxi, a command center from a flight tower for commercial airliners, and so on. Further, the one or more means of control may allow for an abortion of a flight plan or change of direction of the drone taxi at any given point of time, such as through real-time telemetry and satellite positioning of the drone and the passenger pod, and so on. Further, the drone taxi may be designed so as to keep the weight of the drone taxi (constituted by the passenger pod) underneath the drone taxi for safety reasons and to keep the center of gravity underneath. Further, the drone taxi may be applied in contexts that may include industry, emergency, agricultural, transport, disasters, construction, remote aid, mapping and so on. Further, the drone taxi may be used for rescue by sea wherein passenger pod may be able to get into tighter places that conventional helicopters may not and may save lives. Further, each ocean carrier may carry the drone taxi along and may be used as a lifesaving preserver. Further, the drone taxi may be used for rescue by land wherein the drone taxi may be used in rescues from avalanches and mountain climbers that may get injured. Further, it may be used in search and find people who may be lost, using the visual cameras. Further, the drone taxi may be used for food care packages and medicine delivery. Further, the drone taxi may guide through heavy jungles and terrain getting immediate aid to various tribes or people who may need it. Further, the drone taxi may be used for rescue from natural hazards wherein flood victims may be rescued by emergency teams who may use the drone taxi to pick up people who may be in immediate need. Further, the drone taxi may be used for delivery service. Further, the drone taxi may be used for Sightseeing wherein a glass bowl may be created for viewing around that may allow fantastic views of very hard to reach areas. Further, the drone taxi may be used for places where helicopters can't go to provide any kind of service required. Further, the drone taxi may not need an airport to land and may land anywhere depending on designed landing gear. Further, the drone taxi may be franchised out for businesses to use and pilots may be rented. Further, the drone taxi may employ various skilled workers, engineers, administrators, some with degrees some without. Further, the drone taxi may be modular and transportable. Further, the drone taxi may have developed its own unique type of connectors and interchangeable designs.

Further, the disclosed flying taxi may provide 360-degree surrounding awareness that may be monitored by a remote pilot. Further, the flying taxi may include fast information relays to the control station.

The drone taxi may be completely modular in design and may use a very creative and one of a kind umbilical connector. Further, the drone taxi may be manned and inspected by qualified technicians and quality control using the 6-star sigma maximo program. Further, the drone taxi may eliminate the need for a pilot license to fly the drone taxis by the operator/passenger. Further, the drone taxi may create jobs for highly skilled down to the mechanic and technicians. Further, the drone taxi may be used by other companies renting these facilities to pilot their crafts. Further, enclosed shrouded turbine engines may be used to protect the one or more passengers and passerby using bottom cages that may shield the turbine motor. Further, every piece of ground equipment may be specially designed for a specific use in the repair, connecting, and launch from a launchpad. Further, new buildings may not be required to launch the drone taxi. Further, the drone taxi may not require permits to land on rooftops with the unique and original launch pads.

Further, the drone taxi may include 4 Motors that produce 250 lbs of thrust each. Further, the drone taxi may include an avoidance flight controller and a software built-in. Further, the drone taxi may facilitate full telemetry and 4 means of operations to control the drone taxi. Further, the modular taxi comes apart for easy repair, transport or assembly that may be made from carbon fiber and 3D printed. Further, recharging stations associated with the drone taxi may be inspected daily for quality control. Further, the disclosed flying taxi may create jobs and takes the worry away from the passenger to fly. Further, the drone taxi has many industry uses including natural disaster land or sea rescues. Further, the drone taxi may be adaptable for many uses and attachments with its own unique umbilical connector system. Further, the drone taxi may communicate with the air commercial radar and other air traffic controllers' software. Further, the drone taxi may include built-in safety features. Further, the drone taxi may not require a pilot license for use. Further, the drone taxi may be associated with a Programmed Mobile Launching Design System manned.

Further, complete surveillance and a 360-degree view of the takeoff station, the taxi drone, and the inside of the taxi drone may be incorporated. Further, the drone taxi may incorporate a safety-driven design. Further, the drone taxi may have a licensed pilot that may fly the passenger pod from the launch station. Further, a specific route to keep flying safe, like seeing interstate highways in the sky, may fly the drone taxi. Further, it may keep routes clear and controlled from other traffic or air traffic. Further, the safety-driven design may incorporate a licensed pilot having the ability to fly one drone or several drones. Further, the drone may be versatile and modular allowing preventative maintenance and full operations without any interruptions during use. Further, air traffic control using TCAS-X may allow full communication with other commercial aircraft and aircraft control towers in real-time. Further, the drone taxi may have 8 3D cameras that may allow full telemetry and vision that may give an operator or pilot a full sense at all times of surrounding in real-time. Further, using a fully automated warning with lights, sound, and vision may be to the advantage of the pilot to warn of any obstacles or approaching dangers that may affect this service. Further, the drone taxi may weigh the one or more passenger's weight, because it may be necessary to indicate the weight the drone taxi may be carrying to prevent any overload or unstable type of flight during ride. Further, the batteries may be fully capable of being swapped out during launch sequence and may have power limitations built into software to prevent premature flight failure due to loss of power. Further, the drone taxi may include a Lipo battery. Further, in an exemplary embodiment, the Lipo battery may be 23,000 7 s 25.9 volt, true 25 c rating, weight 6 lbs. Further, the drone taxi may include cameras such as high-resolution full view ball cameras.

Further, the drone taxi may include a hollow frame printed and skinned, modular, and remotely flown as a serviceable flying taxi service for transportation. Further, the drone taxi may pull the load instead of pushing the load. Further, the drone may include an H design in the form of the X pattern for the CPU will allow consumer-available equipment. This will also allow for future alterations of our craft to incorporate new flying techniques using the same equipment. By having “shrouded engines” that are modular will allow for easy replacement and transportation purposes without hindrance to service. We have kept our profile small enough to fit in tight spaces. Further, the drone taxi design will allow “swarm technology” to be easily incorporated into other services and uses that will give our craft many purposes and uses. Most other designs do address these issues.

Further, the drone taxi may use “amazon available” lithium batteries. Further, specially designed 2 stage turbine brushless motors may consume 80% of the battery power leaving 10% for the electronics and surveillance, monitoring equipment inside the passenger pod.

Further, the drone taxi may be designed for various weather effects and may handle all elements of the weather and with the least effect on performance. Further, the drone taxi may include parachutes located in the chamber with the 4 cameras for a safe landing. Another chute will be deployed near the connector plate on top of the passenger pod. Further, the passenger pod may be either carbon fiber printed or manufactured with ribbing and light skin material such as the nose of a helicopter cabin. Further, the passenger pod may include a landing gear. Further, the landing gear may have full suspension. Further, the passenger pod may have all the necessary comforts (such as A/C, heater, windows, etc.) to make the trip the most safe and enjoyable possible. Further, the drone taxi may incorporate the swarm technology and may affect carrying larger and heavier loads or payload with a newly designed landing system. Further, a more secure and reliable source of power may be necessary. Further, with advanced technology ever increasing, soon a reliable and dependable rechargeable battery that may allow more power for a light design may be implemented.

Further, modular pods are designed to connect to the middle center of the drone power body using specially fitted female and male connections. These will be male and female inserts instead of contact plates. Once a Modular Pod is attached to the power body, knurled and threaded sleeves will be screwed onto the shaft that is housed inside of the Middle Power Body (MPB). Once airborne the need for a stronger connector is limited due to the less pull of downward gravity during liftoff. Forward motion will be protected by the use of a special connector that is also designed to be removable. Think of it as a stabilizer bar on a transmission for a car. Further, the modular pods are designed to accept a connector based on the same technology as the stabilizer bars that will be used between the motors. Further, each modular pod will have 3 open connection points that will be used in future operations as swarm technology is developed. With our design now incorporating this future technology into the modular pod, we will be able to just download, upgrade or install the correct electronics or equipment without the need to start over from scratch. This will save much-needed downtime and development resources.

Further, a software platform (or application) associated with the disclosed flying taxi (or aerial vehicle) may facilitate the interaction of one or more riders (or passengers) with service providers of the disclosed flying taxi. Further, the software platform may use internet mapping that may be picked up by the passenger.

Further, upon inspecting the drone taxi, a remote flight mission center in a building is programming the drone to receive its set of instructions on the duties it is to perform. This programmed information is handled by a skilled team of remote pilots, engineers, and personal all required carrying out these tasks. Further, the drone taxi may be controlled by the remote center (or the remote flight mission center) that monitors the telemetry using sensors and cameras built into the drone's main center section. Further, the drone taxi may be associated with a mission control launch center. Further, the mission control launch center may house the tram system, launch area, and storage of the parts to replace pods on the drones. Further, the mission control launch center can also be a charging station for the batteries. There are 4 cameras at the top allowing a full 360 degree of view of the drone's surround area. Further, a camera is attached to each turbine that will show a full view of the landing and launching ground that the drone is taking off from. Further, the remote flight mission center may use flight patterns that are set in place using the TACS X control system that the same commercial airliners use today. This software uses radar to help commercial airliners avoid collisions or interference. With the drone taxi having complete communication between commercial, private and any other airspace will eliminate any possible encounters that may cause an accident. Once a flight pattern has the green light that was programmed for the drone to use at the level of flight it is assigned, the drone taxi may take off from the launch area to land on the designated virtual landing pad that the passenger (operator or civilian) would be using to call for a taxi. Further, the taxi may land on this spot with a marginal error that is calculated for the safety of the passenger and bystanders. Full telemetry will be displayed at all times to the remote flight mission center that is manned and piloted. The drone taxi may use certain instructions to the occupant to land and pick up its passenger. Once the drone taxi completes its task it will return to base to accept another assignment or call, depending on its battery power. By using a remote pilot this will allow the passenger to use the service and fly without using a pilot's license. It is important to note that the drone taxi will be controlled by four different means of control. Further, 4 different means may include Remote from the mission center, Radio (for the contest), Operator of the vehicle, and Command center from a flight tower for commercial airliners. With us giving control to these 4 means of operation should allow for any abortion of the flight plan or change of direction at any given point. This could all be possible by real-time telemetry and satellite positioning of the drone and pod. Visual flight could be accomplished by the 4 onboard cameras. Further, size will be another factor because of the 8 feet 5-inch limitations of the contest.

Further, an administration building and remote pilot center may house the pilots, the electronics for the telemetry and equipment to fly the drones by remote. The computers will be stored here along with all administrations.

Further, the drone taxi may facilitate rescue by sea. Further, the drone taxi may be able to get into tighter places that conventional helicopters cannot get too in time to save lives. Each ocean carrier could carry our drone along as used as a lifesaver preserver. The drone can be used in rescues from avalanches, mountain climbers that fell are hurt. Further, the drone taxi could be used in search and find people who are lost using the visual cameras. Further, the drone taxi may facilitate food care packages and medicine delivery. Further, the drone taxi can be guided through heavy jungles and terrain getting immediate aid to the tribe or people who need it. Flood victims can be rescued by emergency teams who use our modular designed drone to pick people who are in immediate need. Further, the drone taxi may facilitate delivery service and sightseeing. We can create a glass bowl viewing pod that will allow fantastic views of very hard reaching areas unless used by sky cars. Further, the drone taxi may help where helicopters can't go. Further, no need for airports can possibly land anywhere depending on the designed landing gear. Further, the drone taxi may be franchised out for business to use and our pilots can be rented for the franchise. (this creates a huge job market). Our service will employ various styles or workers, engineers, administrators, jobs, jobs, jobs some with degrees some without. Our drone is modular transportable. Further, the drone taxi may facilitate swarm technology: The imagination is the limit when using swarm technology. Further, the drone taxi may include its own unique type of connectors and interchangeable designs. By using the taxi idea you have a licensed pilot that flies the passenger pod from the pod station. The taxi will be flown by a specific route to keep flying safe, like seeing interstate highways in the sky. It would keep routes clear and controlled from other traffic or air traffic such as using stop lights and signs. Licensed pilots may be able to fly one drone or several drones. Further, the drone is versatile and modular allowing preventative maintenance and full operations without any interruptions during use. Furner, air traffic control using the TCAS-X will allow full communication with other commercial aircraft and aircraft control towers in real-time. Further, the drone taxi may include 8 3D cameras that allow full telemetry and vision gives the operator or pilot full sense at all times of his surroundings in real-time. Using a fully automated warning with lights, sound, and visual will be to the advantage of the pilot to warn of any obstacles or approaching dangers that could affect this service. Further, the drone taxi may have a scale to weigh the passenger's weight is necessary to indicate what the taxi will be carrying to prevent any overload or unstable type of flight during the ride. The batteries are fully capable of being swapped out during the launch sequence and have power limitations built into the software to prevent premature flight failure due to the loss of power.

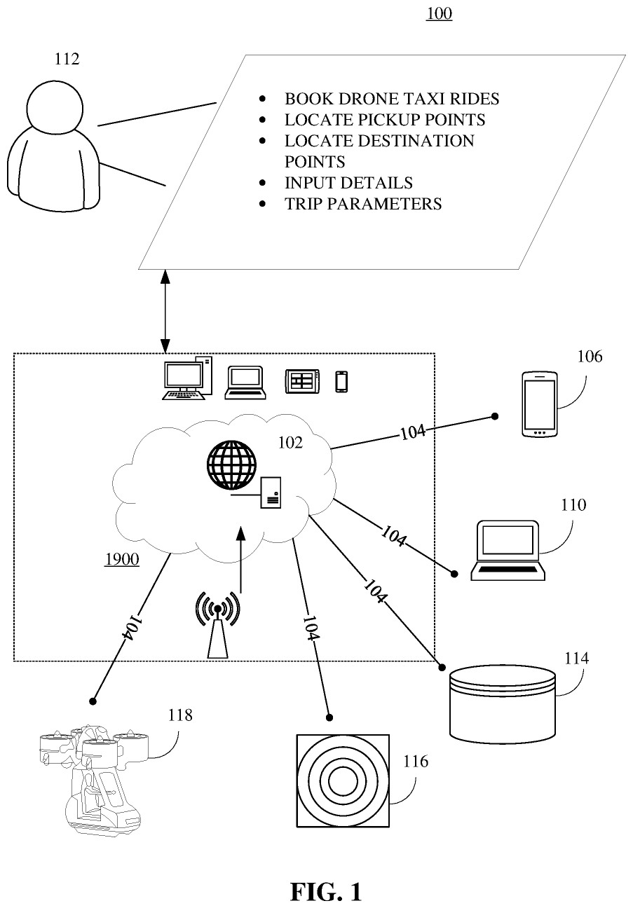

Now referring to figures, FIG. 1 is an illustration of an online platform 100 consistent with various embodiments of the present disclosure. By way of non-limiting example, the online platform 100 to facilitate transportation of payloads may be hosted on a centralized server 102, such as, for example, a cloud computing service. The centralized server 102 may communicate with other network entities, such as, for example, a mobile device 106 (such as a smartphone, a laptop, a tablet computer etc.), other electronic devices 110 (such as desktop computers, server computers etc.), databases 114, and sensors 116, flying taxi 118 over a communication network 104, such as, but not limited to, the Internet. Further, users of the online platform 100 may include relevant parties such as, but not limited to, end-users, administrators, service providers, service consumers and so on. Accordingly, in some instances, electronic devices operated by the one or more relevant parties may be in communication with the platform.

A user 112, such as the one or more relevant parties, may access online platform 100 through a web based software application or browser. The web based software application may be embodied as, for example, but not be limited to, a website, a web application, a desktop application, and a mobile application compatible with a computing device 1900.

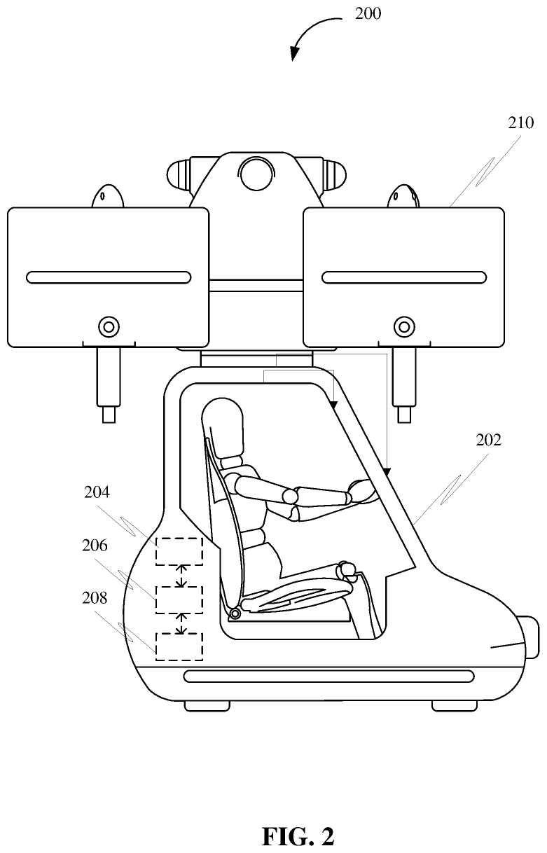

FIG. 2 is a flying taxi 200 for facilitating the transportation of payloads, in accordance with some embodiments. Accordingly, the flying taxi 200 may include at least one pod 202, a processing device 206, a presentation device 208, and at least one aerial vehicle 210.

Further, the at least one pod 202 may be configured to receive at least one payload. Further, the at least one pod 202 may include at least one weight sensor 204 disposed on the at least one pod 202. Further, the at least one payload may include at least one of passenger, cargo, etc. Further, the at least one weight sensor 204 may be configured to generate at least one weight data corresponding to a weight of a payload of the at least one payload.

Further, the processing device 206 may be communicatively coupled with the at least one weight sensor 204. Further, the processing device 206 may be configured for analyzing the at least one weight data. Further, the processing device 206 may be configured for generating at least one notification based on the analyzing.

Further, the presentation device 208 may be communicatively coupled with the processing device 206. Further, the presentation device 208 may be configured for presenting the at least one notification.

Further, the at least one aerial vehicle 210 may be detachably couplable with the at least one pod 202 using at least one coupling mechanism. Further, the at least one aerial vehicle 210 may include at least one propeller assembly disposed on an aerial vehicle of the at least one aerial vehicle 210. Further, the at least one propeller assembly may be configured for propelling the flying taxi 200.

In further embodiments, the flying taxi 200 may include at least one airfoil assembly (not shown) disposed on at least one of each pod 202 and each aerial vehicle 210. Further, the at least one airfoil assembly generates at least one resistive force on the flying taxi 200 in opposition to a gravitational force on the flying taxi 200 during a descent of the flying taxi 200.

Further, in some embodiments, the at least one airfoil assembly may be configured in an un-deployed configuration and at least one deployed configuration. Further, the at least one airfoil assembly may be configured to transition between the un-deployed configuration and the at least one deployed configuration. Further, the at least one airfoil assembly generates the at least one resistive force in the at least one deployed configuration. Further, the at least one airfoil assembly does not generate the at least one resistive force in the un-deployed configuration.

Further, in some embodiments, the at least one coupling mechanism may include a first part disposed on the at least one aerial vehicle 210 and a second part disposed on the at least one pod 202. Further, the first part and the second part may be detachably coupled facilitating the at least one aerial vehicle 210 to be detachably couplable with the at least one pod 202.

In further embodiments, the flying taxi 200 may include at least one actuator (not shown) operationally coupled with the at least one aerial vehicle 210. Further, the at least one actuator may be configured to couple the at least one aerial vehicle 210 with the at least one pod 202 and decoupled the at least one aerial vehicle 210 from the at least one pod 202.

Further, in some embodiments, the at least one actuator may include a handle. Further, the handle may be configured to receive at least one external force manually. Further, the handle may be configured to transition between a lock position and an unlock position. Further, the at least one aerial vehicle 210 may be coupled with the at least one pod 202 in the lock position and the at least one aerial vehicle 210 may be decoupled from the at least one pod 202 in the unlock position.

Further, in some embodiments, the at least one pod 202 may include at least one pod foot. Further, the at least one pod foot may be configured in at least one pod foot configuration. Further, the at least one pod foot configuration facilitates placing of the at least one pod 202 on at least one surface in at least one pod orientation in relation to the at least one surface.

Further, in some embodiments, the at least one aerial vehicle 210 may include at least one vehicle positioning foot. Further, the at least one vehicle positioning foot facilitates placing of the at least one aerial vehicle 210 coupled with the at least one pod 202 on at least one surface and the at least one aerial vehicle 210 decoupled from the at least one pod 202 on the at least one surface.

Further, in some embodiments, the at least one vehicle positioning foot may be configured in a retracted configuration and at least one extended configuration. Further, the at least one vehicle positioning foot may be configured to transition between the retracted configuration and the at least one extended configuration. Further, the at least one extended configuration facilitates the placing of the at least one aerial vehicle 210 on the at least one surface and the retracted configuration does not facilitate the placing of the at least one aerial vehicle 210 on the at least one surface.

Further, in some embodiments, the at least one propeller assembly may be associated with at least one engaged state and a disengaged state. Further, the at least one propeller assembly propels the flying taxi 200 in the at least one engaged state. Further, the at least one propeller assembly does not propel the flying taxi 200 in the disengaged state. Further, the at least one propeller assembly may be configured to transition between the at least one engaged state and the disengaged state.

Further, in some embodiments, the processing device 206 may be configured for generating at least one propeller control command based on the analyzing of the at least one weight data. Further, the flying vehicle further may include at least one propeller actuator (not shown) communicatively coupled with the processing device 206. Further, the at least one propeller actuator may be operationally coupled with the at least one propeller assembly. Further, the at least one propeller actuator configured to transition the at least one propeller assembly between the at least one engaged state and the disengaged state based on the at least one propeller control command.

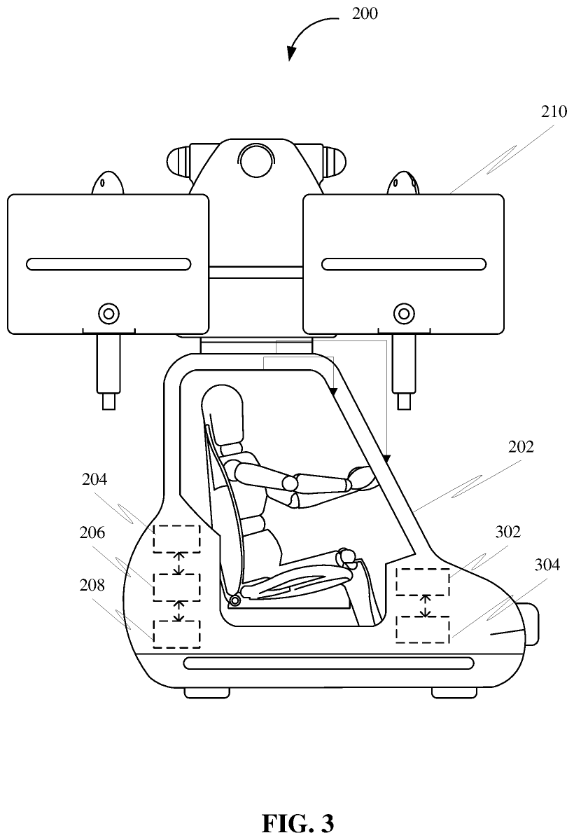

FIG. 3 is the flying taxi 200 for facilitating the transportation of payloads, in accordance with further embodiments. Accordingly, the flying taxi 200 may include at least one airfoil sensor 302 and at least one airfoil actuator 304. Further, the at least one airfoil sensor 302 may be disposed on the at least one of the each aerial vehicle 210 and the each pod 202. Further, the at least one airfoil sensor 302 may be configured to generate at least one airfoil sensor data corresponds to at least one state of the at least one of the each aerial vehicle 210 and the each pod 202 in relation to at least one surface. Further, the at least one state may be associated with a position, altitude, rate of change in altitude, rate of change in position, etc. of the flying taxi 200. Further, the processing device 206 may be communicatively coupled with the at least one airfoil sensor 302. Further, the processing device 206 may be configured for analyzing the at least one airfoil sensor data. Further, the processing device 206 may be configured for generating at least one airfoil control command.

Further, the at least one airfoil actuator 304 may be communicatively coupled to the processing device 206. Further, the at least one airfoil actuator 304 may be operationally coupled with the at least one airfoil assembly. Further, the at least one airfoil actuator 304 may be configured to transition the at least one airfoil assembly between the un-deployed configuration and the at least one deployed configuration based on the at least one airfoil control command.

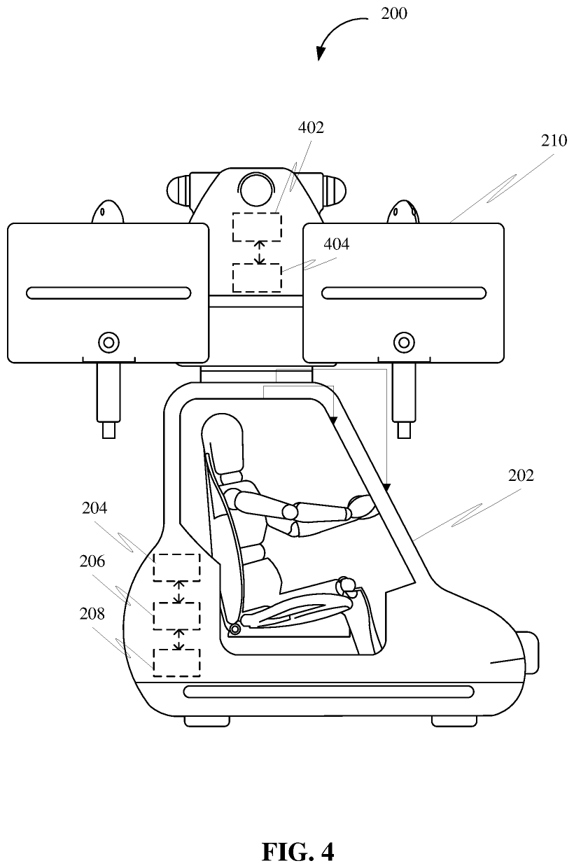

FIG. 4 is the flying taxi 200 to facilitate transitioning of a vehicle positioning foot, in accordance with further embodiments. Accordingly, the flying taxi 200 may include at least one vehicle sensor 402 and at least one vehicle actuator 404. Further, the at least one vehicle sensor 402 may be disposed on the at least one aerial vehicle 210. Further, the at least one vehicle sensor 402 may be configured to generate at least one vehicle sensor data. Further, the at least one vehicle sensor data corresponds to at least one state of the at least one aerial vehicle 210 in relation to the at least one surface. Further, the at least one state may be associated with a position, altitude, rate of change in altitude, rate of change in position, etc. of the flying taxi 200. Further, the processing device 206 communicatively coupled with the at least one vehicle sensor 402. Further, the processing device 206 may be configured for analyzing the at least one vehicle sensor data. Further, the processing device 206 may be configured for generating at least one vehicle command based on the analysing.

Further, the at least one vehicle actuator 404 may be communicatively coupled to the processing device 206. Further, the at least one vehicle actuator 404 may be operationally coupled with the at least one vehicle positioning foot. Further, the at least one vehicle actuator 404 may be configured for transitioning the at least one vehicle positioning foot between the retracted configuration and the at least one extended configuration based on the at least one vehicle command.

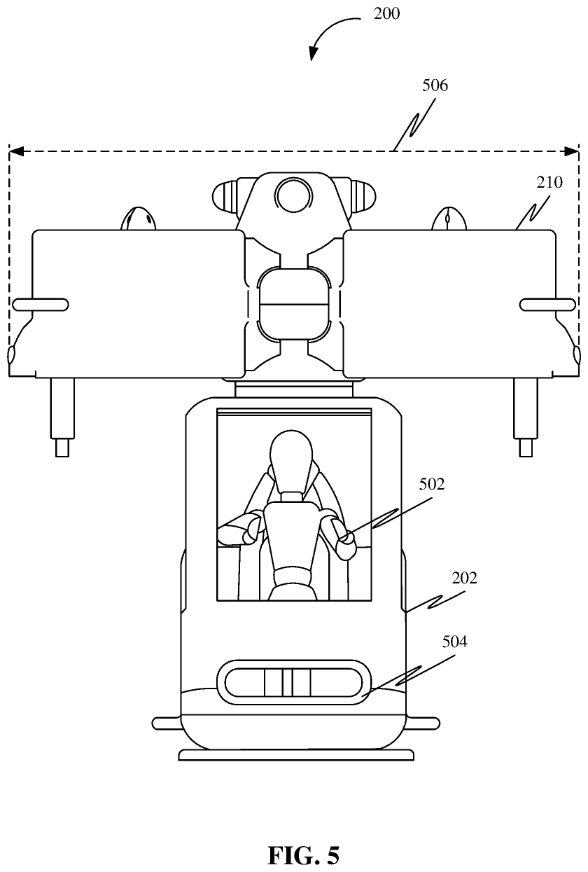

FIG. 5 is a front view of the flying taxi 200, in accordance with exemplary embodiments. Accordingly, the flying taxi 200 may be controllable by one or more means of control such as through remote control from a mission center, a radio device, one or more passengers 502 of the flying taxi 200, a command center from a flight tower for commercial airliners, and so on. Further, in an exemplary embodiment, the at least one aerial vehicle 210 may be associated with a width 506 (may be 8′-1 3/16″). Further, the flying taxi 200 may include a lighting system 504.

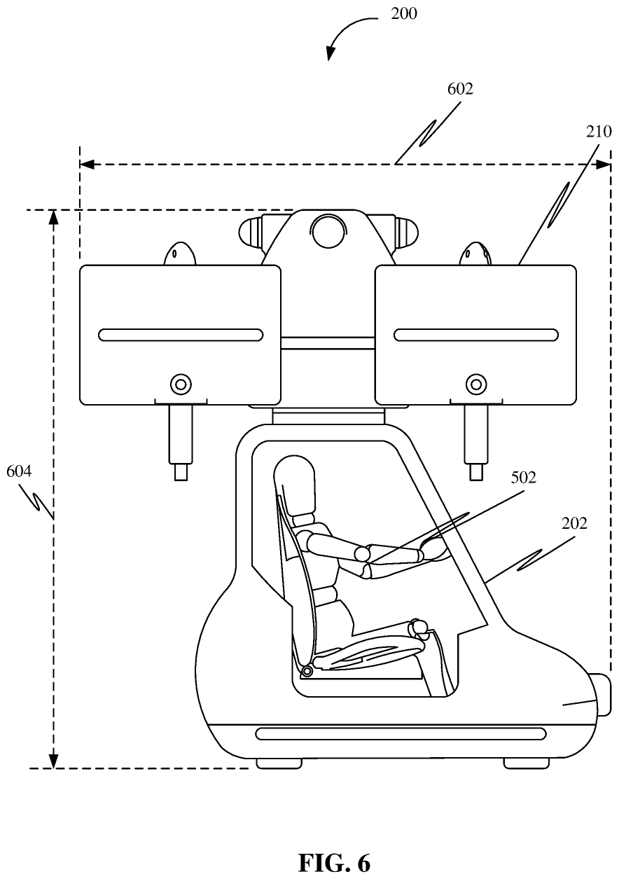

FIG. 6 is a side view of the flying taxi 200, in accordance with exemplary embodiments. Accordingly, in an exemplary embodiment, the at least one aerial vehicle 210 may be associated with a length 602 (may be 7′11″). Further, the flying taxi 200 may be controlled/operated by the one or more passenger 502. Further, in an exemplary embodiment, the flying taxi 200 may be associated with a height 604 (may be 8′-4 1/16″).

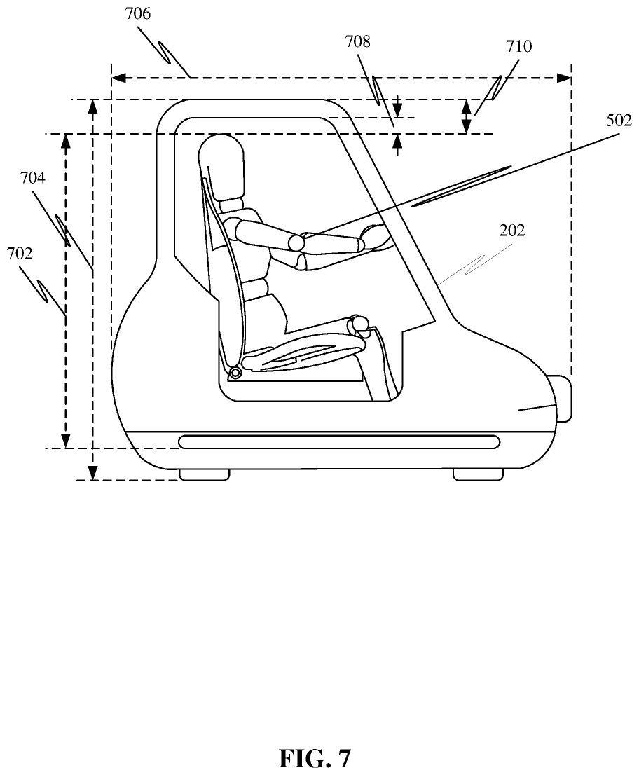

FIG. 7 is a side view of the at least one pod 202 of the flying taxi 200, in accordance with exemplary embodiments. Accordingly, the at least one pod 202 may be controlled by the one or more passengers 502. Further, in an exemplary embodiment, a height 702 may be 4′-2¾″. Further, a height 708 may be 2 11/16″. Further, a height 710 may be 5 11/16″. Further, a height 704 may be 5′-1¾″. Further, a width 706 may be 6′-2½″.

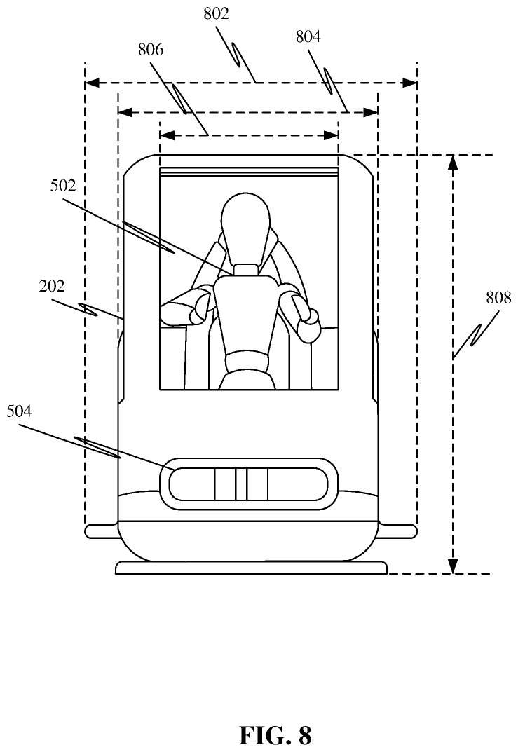

FIG. 8 is a front view of the at least one pod 202 of the flying taxi 200, in accordance with exemplary embodiments. Accordingly, the at least one pod 202 may be controlled by the one or more passengers 502. Further, the at least one pod 202 may include a lighting system 504. Further, in an exemplary embodiment, a width 802 may be 4′-1⅛″. Further, a width 804 may be 3′-2 5/16″. Further, a width 806 may be 2′-2 5/16″. Further, a height 808 may be 5′-1¾″.

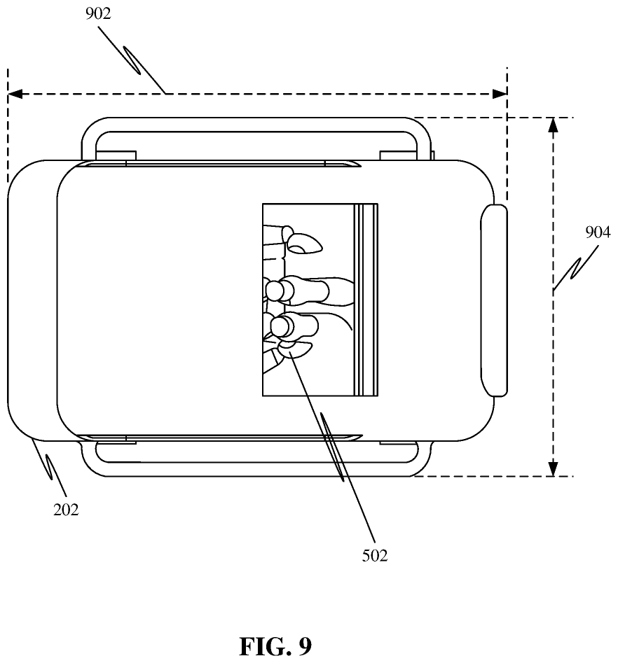

FIG. 9 is a top view of the at least one pod 202 of the flying taxi 200, in accordance with exemplary embodiments. Further, a length 902 associated with the at least one pod 202 may be 6′-2½″. Further, a width 904 may be 4′-1⅛″.

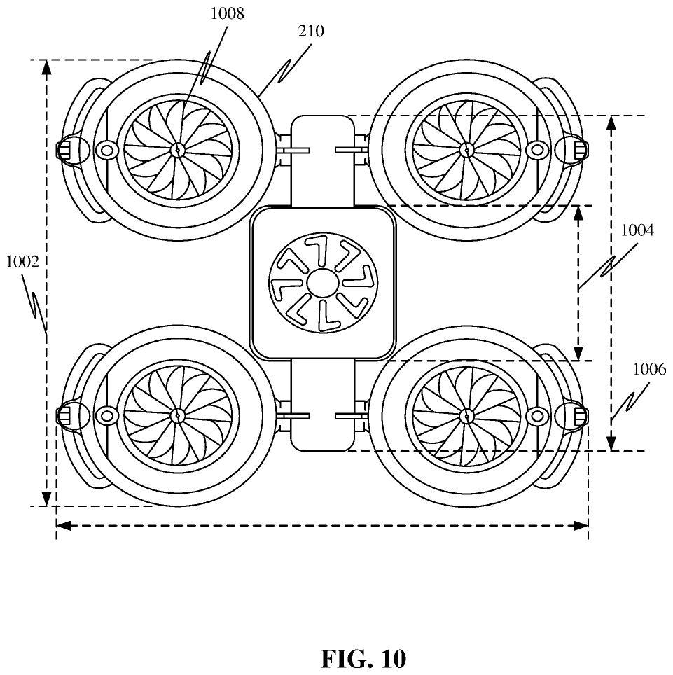

FIG. 10 is a top view of the at least one aerial vehicle 210, in accordance with exemplary embodiments. Accordingly, the at least one aerial vehicle 210 may include a 2 stage turbine engine 1008. Further, in an exemplary embodiment, a width 1002 associated with the at least one aerial vehicle 210 may be 7′-5¼″. Further, a length 1004 may be 2′-6¼″. Further, a length 1006 may be 5′-6⅝″.

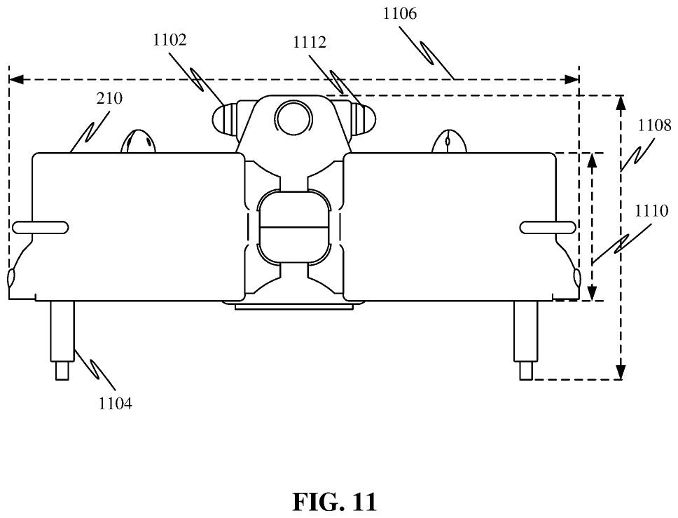

FIG. 11 is a side view of the at least one aerial vehicle 210 of the flying taxi 200, in accordance with exemplary embodiments. Accordingly, the at least one aerial vehicle 210 may include a plurality of full perimeter cameras 1102, 1112 and a positioning feet 1104. Further, the plurality of full perimeter camera 1102, 1112 may be powered by LiPo batteries and controlled by a CPU. Further, the positioning feet 1104 may be equipped with one or more sensors. Further, in an embodiment, the positioning feet 1104 may include fitted suspension devices. Accordingly, the positioning feet 1104 may allow the at least one aerial vehicle 210 to take-off and land independently of the at least one pod 202, and for emergencies such as when the at least one aerial vehicle 210 may land unexpectedly. Further, in an exemplary embodiment, a length 1106 may be 8′- 15/16″.Further, a width 1108 may be 4′-¼″. Further, a width 1110 may be 2′-1″.

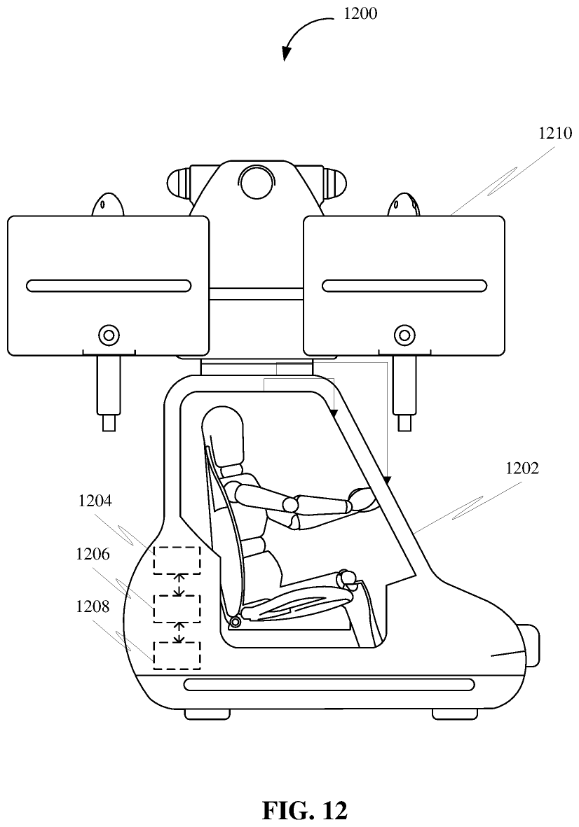

FIG. 12 is a flying taxi 1200 for facilitating the transportation of payloads, in accordance with some embodiments. Accordingly, the flying taxi 1200 may include at least one pod 1202, a processing device 1206, a presentation device 1208, at least one aerial vehicle 1210, and at least one airfoil assembly (not shown). Further, the at least one pod 1202 may be configured to receive at least one payload. Further, the at least one pod 1202 may include at least one weight sensor 1204 disposed on the at least one pod 1202. Further, the at least one weight sensor 1204 may be configured to generate at least one weight data corresponding to a weight of a payload of the at least one payload. Further, the at least one payload may include at least one of passenger, cargo, etc.

Further, the processing device 1206 may be communicatively coupled with the at least one weight sensor 1204. Further, the processing device 1206 may be configured for analyzing the at least one weight data. Further, the processing device 1206 may be configured for generating at least one notification based on the analyzing a presentation device 1208 communicatively coupled with the processing device 1206. Further, the presentation device 1208 may be configured for presenting the at least one notification.

Further, the at least one aerial vehicle 1210 may be detachably couplable with the at least one pod 1202 using at least one coupling mechanism. Further, the at least one aerial vehicle 1210 may include at least one propeller assembly disposed on an aerial vehicle of the at least one aerial vehicle 1210. Further, the at least one propeller assembly may be configured for propelling the flying taxi 1200.

Further, the at least one airfoil assembly may be disposed on at least one of each pod 1202 and each aerial vehicle 1210. Further, the at least one airfoil assembly generates at least one resistive force on the flying taxi 1200 in opposition to a gravitational force on the flying taxi 1200 during a descent of the flying taxi 1200.

Further, in some embodiments, the at least one airfoil assembly may be configured in an un-deployed configuration and at least one deployed configuration. Further, the at least one airfoil assembly may be configured to transition between the un-deployed configuration and the at least one deployed configuration. Further, the at least one airfoil assembly generates the at least one resistive force in the at least one deployed configuration. Further, the at least one airfoil assembly does not generate the at least one resistive force in the un-deployed configuration.

Further. in some embodiments, the at least one coupling mechanism may include a first part disposed on the at least one aerial vehicle 1210 and a second part disposed on the at least one pod 1202. Further, the first part and the second part may be detachably coupled facilitating the at least one aerial vehicle 1210 to be detachably couplable with the at least one pod 1202.

In further embodiments, the flying taxi 1200 may include at least one actuator (not shown) operationally coupled with the at least one aerial vehicle 1210. Further, the at least one actuator may be configured to couple the at least one aerial vehicle 1210 with the at least one pod 1202 and decoupled the at least one aerial vehicle 1210 from the at least one pod 1202.

Further, in some embodiments, the at least one actuator may include a handle. Further, the handle may be configured to receive at least one external force manually. Further, the handle may be configured to transition between a lock position and an unlock position. Further, the at least one aerial vehicle 1210 may be coupled with the at least one pod 1202 in the lock position and the at least one aerial vehicle 1210 may be decoupled from the at least one pod 1202 in the unlock position.

Further, in some embodiments, the at least one pod 1202 may include at least one pod foot. Further, the at least one pod foot may be configured in at least one pod foot configuration. Further, the at least one pod foot configuration facilitates placing of the at least one pod 1202 on at least one surface in at least one pod 1202 orientation in relation to the at least one surface.

Further, in some embodiments, the at least one aerial vehicle 1210 may include at least one vehicle positioning foot. Further, the at least one vehicle positioning foot facilitates placing of the at least one aerial vehicle 1210 coupled with the at least one pod 1202 on at least one surface and the at least one aerial vehicle 1210 decoupled from the at least one pod 1202 on the at least one surface.

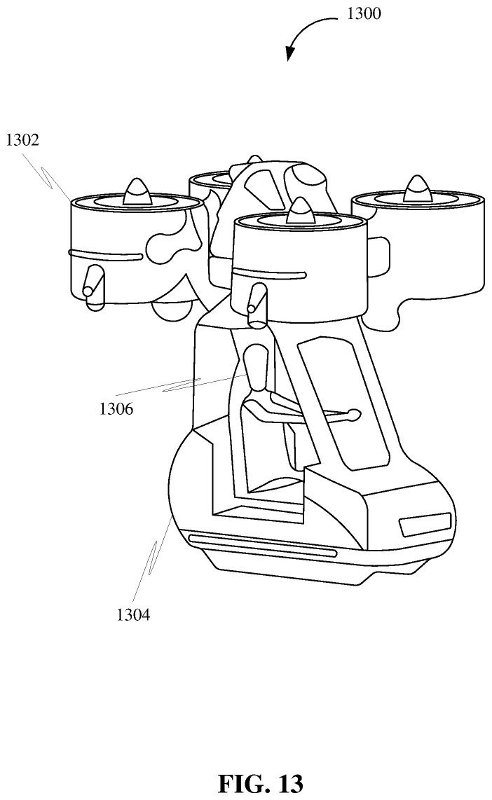

FIG. 13 shows an exemplary representation of a drone taxi 1300, in accordance with some embodiments. Further, the drone taxi 1300 may be an automated vehicle and may include a combination of a passenger pod 1304 and a drone 1302. Further, the drone taxi 1300 may be controllable by one or more means of control such as through remote control from a mission center, a radio device, one or more passengers 1306 of the drone taxi 1300, a command center from a flight tower for commercial airliners, and so on. Further, the one or more means of control may allow for an abortion of a flight plan or change of direction of the drone taxi 1300 at any given point of time, such as through real-time telemetry and satellite positioning of the drone 1302 and the passenger pod 1304, and so on. Further, the drone taxi 1300 may be designed so as to keep a weight of the drone taxi 1300 (constituted by the passenger pod 1304) underneath the drone taxi 1300 for safety reasons and to keep the center of gravity underneath. Further, the drone taxi 1300 may require no pilot license for use. Further, the drone 1302 of the automated drone taxi 1300 may be a drone manufactured by MicroPilot™. Further, the MicroPilot™drone may include a 150 MIPS RISC processor for scalability, upward compatible with MP2028g2™. Further, the drone 1302 may include a small UAV autopilot (28 grams, 4 cm×10 cm), and additional features including, but not limited to, GPS waypoint navigation with altitude and airspeed hold, completely independent takeoff, bungee launch, hand launch, and landing, powerful command set, fully integrated with 3-axis gyros/accelerometers, GPS, pressure altimeter, pressure airspeed sensors extensive data logging and telemetry, and so on. Further, the drone 1302 may include HORIZON^{mp} ground control software, with avoidance flight controllers and software built-in.

Further, the drone taxi 1300 may be controlled by a remote control center, located in a remote location, and may monitor telemetry using one or more sensors and cameras built included in the drone taxi 1300. For instance, a plurality of cameras at the top of the drone 1302 may allow a full 360 degree of view of surroundings, landing and launching ground that the drone taxi 1300 may take-off from, and so on. Further, the remote control center may use standard and predefined flight patterns that may be set in place using a Traffic Collision Avoidance System (TCAS) control system. Further, the TCAS control system may use radars to help the drone taxi 1300 to avoid collisions or interference. Further, the drone taxi 1300 may communicate with air commercial radar and software applications of other air traffic controllers. Further, the drone taxi 1300, and the remote control center may have a complete communication with commercial, private and other airspace, corresponding air traffic control centers to eliminate any possible encounters that may cause an accident. Further, once a flight pattern of the drone taxi 1300 is approved, the drone taxi 1300 may take off from a launch area to land at a designated docking station. Further, the docking station may include a space with a landing spot, and a marginal error area that may be calculated for the safety of the one or more passengers 1306 and bystanders if any. Further, full telemetry may be displayed at all times to the remote control center that may be manned and piloted about the drone taxi 1300 and surrounding area. Further, the drone taxi 1300 may include one or more communication mechanisms to communicate with one or more passengers of the drone taxi 1300, including, but not limited to one-way transmission screens, radios, cellular devices, and so on. Further, the one or more passengers 1306 may be indicated a take-off and/or landing location through the one or more communication mechanisms. Further, in an instance, the communication mechanism may include a fully automated warning with lights, sound, and visuals that may be to the advantage of a remote pilot to warn of any obstacles or approaching dangers that may affect service of the drone taxi 1300.

Further, the remote control center may communicate with, and control the drone taxi 1300 over a communication network, such as a mobile network, 4G LTE, and so on over an unlimited range of control. Further, telemetry may be streamed and relayed, along with visual communication, and information transfer in real-time over the communication network. Further, usage of high zoom cameras, sensory equipment and real-time telemetry (wireless telemetry) for remote pilots to use during flight, takeoff, and landing may be supported over the communication network. Accordingly, the drone taxi 1300 may be operated worldwide, and even in remote areas. Further, the wireless telemetry may facilitate endless communication networks all over the planet. Further, a 150 Nanosecond delay may exist in communication between the drone taxi 1300 and controller or remote operator during takeoff, landing, and flight. Further, the development of the 5G is still under scrutiny and review by various companies. The 4G LTE that is now available will have to be used until the 5G is finally tested for commercial use and regulated. This is much better than GPS which on some accounts has a full 2-second delay between the craft and the remote pilot. Most competitors have yet to discover this method in a drone taxi system and most rely on the pilot method from a First Person View (FPV).

Further, the drone taxi 1300 may incorporate Swarm Technology to allow usage of one drone taxi for many uses with other drone taxis of a similar type, such as to fly larger payloads, cargo, to download, upgrade or install correct electronics or equipment, and in many types of configurations using a plurality of drone taxis 1300 as needed.

Further, the drone 1302 and the passenger pod 1304 may be connected by using umbilical connector (UBC) male and female plates. Further, the umbilical connector may consist of two matching plates that may interlock by means of a specially designed hub pattern. Further, a first umbilical connector plate of the two umbilical connector plates may include slots with tapered slits that may hold a second umbilical connector plate in place, while automatic pins may insert into locking slots securing the two umbilical connector plates together. Further, in an instance, the pins may be inserted manually with physical inspections to ensure an absolute positive connection to the passenger pod 1304. Further, a center of the UBC may carry all of the female and male contact connections. Further, the UBC may provide power to electronics, one or more safety devices, one or more lights, one or more accessory equipment, and one or more audio equipment in the passenger pod 1304.

Further, the drone 1302 and the passenger pod 1304 of the drone taxi 1300 may include one or more handles to facilitate manual docking and undocking of the passenger pod 1304 to the drone 1302.

Further, the drone taxi 1300 may include a built-in air-foil mechanism to facilitate slow descent during flight failures such as during emergency or crash landing. The airfoil may be deployed, automatically, or manually during flight failure, and may produce an aerodynamic force-generating drag, and lift, thereby slowing the descent of the drone taxi 1300.

Further, the drone taxi 1300 may include one or more air-bags integrated within the passenger pod 1304 to facilitate cushioning during emergency/crash landing

Further, energy to safely operate the passenger pod 1304 may be supplied by one or more Removable Charging Packs (RCPs) located underneath a top equipment monitoring housing of the drone 1302. Further, the one or more RCPs may be stored under the passenger pod 1304 and may be designed to be removable for charging, replacement and inspections. Further, each RCP of the one or more RCPs may house necessary lithium or energy style rechargeable power sources that may be used by the drone taxi 1300. Further, the drone taxi 1300 may include a reusable and easy to dock in and dock out the type of battery pack. Further, specially designed two-stage turbine brushless motors may be implemented in the one or more RCPs. Further, the passenger pod 1304 may be configured to consume 80% of the battery power leaving 10% for the electronics and surveillance, monitoring equipment, and so on located inside the passenger pod 1304. Further, the lithium battery used may be a Lithium Polymer (LiPo) battery. Further, the LiPo battery may have specifications such as 22,000 mah capacity, 12 S 44.4 volts, true 40 C rating, lifetime warranty, 5 C fast charge capable, 100% waterproof, built with factory fresh cells, built with genuine 12 awg Deans Ultra wire, a connector and JST-XH balancing tap, 158 mm×118 mm×121 mm, 5050 g and so on. Further, the LiPo battery may be fully capable of being swapped out during the launch sequence of the drone taxi 1300 and may have power limitations built to prevent premature flight failure due to the loss of power.

Further, the drone taxi 1300 may contain Helium filled Aerostat balloons (HAB). Further, HAB may serve two purposes in the drone taxi 1300. Further, one purpose may be to be used as a means to increase lifting capabilities of turbine motors of the drone 1302, during takeoff and landing. Further, specifically designed cradles may contain helium and one or more structures that may form the shape of a balloon. Further, an escape or release valve may be incorporated into each cradle for emergency release of helium before, during or after flight. Further, the cradle may be attached to the passenger pod 1304. Further, lift ratio of helium to when helium may be not present is 1 to 3 in cubic feet/lbs. Further, using HAB may help in reducing the use of motor and the drain of batteries. Further, second purpose may be for safety reasons. For instance, if a motor of the drone 1302 failed, the other remaining motors may go into one of two modes. A first mode of the two modes may include a free turning of blades with no resistance on armature or motor shaft, and a second mode may include a retro spin action allowing other motors to either free spin or motorize spin in opposite direction allowing a braking method to slow down the passenger pod 1304. Further, the HAB may help reduce drag while keeping the descending drone taxi in a safe level plane for safety of the one or more passengers 1306. Further, weight of the HAB may be high enough to increase drag, but low enough to not increase a speed of descent.

Further, one or more parachutes located in the passenger pod 1304 with the four cameras may be used for a safe landing. Further, another chute may be deployed near the connector plate on top of the passenger pod 1304.

Further, the drone taxi 1300 may include a flight controller back up for an automatic return to the last known landing area if there is any communication failure. Further, the flight controller may include a Woo Kong M flight system. Further, the Woo Kong M flight system may include Global Positioning System (GPS) led 3 autopilot modes. Further, the Woo Kong M flight system may include a 2 axis gimbal support with low battery protection. Further, Woo Kong M flight system may include an S-BUS/S 2 PPM receiver. Further, the drone taxi 1300 may incorporate space for cargo, luggage and carry on.

Further, the drone taxi 1300 may be taken out of service until fixed if the drone taxi 1300 does not clear one or more safety inspections performed.

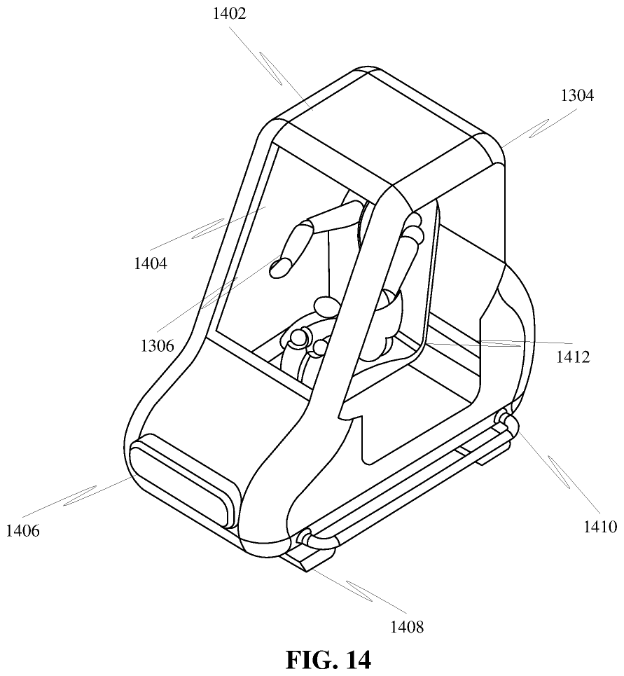

FIG. 14 is an exemplary representation of the passenger pod 1304, in accordance with some embodiments. Further, the passenger pod 1304 may incorporate one or more chutes 1402 for emergency landings, a connector plate that may be designed to release the one or more chutes 1402 remotely or by an operator in case of failure, a large visual window 1404, a lighting system 1406 to navigate at night and for other purposes, a low profile stable foot 1408 that may secure the passenger pod 1304 for launch, handles 1410 for securing passenger pod 1304 just before launch, one or more light custom made seat 1412 that may be adjustable and so on. Further, the passenger pod 1304 may be designed for a passenger 1306 that may be 6.4′ tall. Further, the passenger pod 1304 may include a hollow frame design to keep a check on weight. Further, processes that may be used to develop the passenger pod 1304 may require fitting and trimming to get the required shape. Further, the passenger pod 1304, and the drone taxi 1300 may be manufactured to allow a structure and frame to endure engine vibrations, resonance, and to be able to carry weight of equipment, the drone 1302 and its motors, the one or more passengers 1306 and so on. For instance, ribbing or holed parts may be used throughout the frame of the passenger pod 1304 using adhesives and spars to create desired shape. Further, in an instance, the frame of the passenger pod 1304 may be 3D printed and spar and wrapped in carbon fiber for looks and for any special parts that may be used. Further, the passenger pod 1304 may be built-in panels, sections, and parts and not as a whole unit. Further, a shaker type of machine may be used to vibrate and simulate motor vibrations to simulate motor resonance. Further, one or more methods known in the art may be used to create and skin the frame. Further, all printable materials may bind to carbon fiber sheets or fabric, with resins. Further, the process of manufacturing the passenger pod 1304 may include using 3-D printed parts as a layup model, laying the fabric on top and applying a first thin layer of resin, followed by a second layer of fabric with a more generous layer of resin. Further, the frame of the drone taxi 1300 may be made out of CF Hexagonal tubing, only needing to print the connection pieces and connecting the tubes together. Further, printed and laminated side panels may be mounted to the frame after being tested for fabrication and machining, static, fatigue, spectrum, creep, impact, tensile, compression, shear, thermal cycling and environmental exposure (−251° C./−420° F. to 1371° C./2500° F.), DSC, DMA, TGA, FTIR, TGA, CTE, void, density, volume fraction, ultrasonic NDE, fatigue, crack growth, damage tolerance and so on. Further, Stereolithography (SLA) may also be used and may include converting liquid materials into solid parts, layer by layer, by selectively curing each layer using a light source in a process called photopolymerization. Further, another printing method used may be Selective laser sintering (SLS), which may include using a laser as a power source to sinter powdered material (typically nylon/polyamide), aiming the laser automatically at points in space defined by a 3D model may bind material together to create a solid structure.

Further, the passenger pod 1304 may be a modular passenger pod. Further, the modular passenger pods may be designed to connect to the middle center of the drone 1302 using specially fitted female and male connections. Further, the modular passenger pod may be attached to the drone 1302, knurled and threaded sleeves may be screwed onto shaft that may be housed inside of the center of the drone 1302. Further, one or more connections may be seated with key locks to ensure that vibration may not cause the modular passenger pod to vibrate off, unthread, or loosen. Further, the modular passenger pod may ensure a continuous operation at all times and availability during the use of the drone taxi service. Further, the modular passenger pod may also allow inspection of each motor while being serviced, or inspected before flight. Further, the modular passenger pod may be tagged and identified for current use in the drone taxi service post-inspection. Further, design of the modular passenger pod and location of the center of gravity may not bear any deformation weight or stress weight. Further, the modular passenger pod may be designed to be centered on the X, Y, and Z-axis. Further, a perfectly balanced motor may give an optimum efficiency energy deliverance during takeoff and landing. Further, modular passenger pod may come apart, it may give the drone taxi 1300 more adaptability to be easily repaired, and easy to maintain during operation without any loss of time or interruption to its services, leading to low maintenance and manufacturing costs, replaceable parts during service, and low prices to manufacture. Further, the passenger pod 1304 may include a scale to weigh the passenger's weight, to indicate weight the drone taxi 1300 may be carrying to prevent any overload or unstable type of flight during ride. Further, the passenger pod 1304 may include a plurality of sensors, such as weight sensors embedded in one or more seats, cameras, and so on. Accordingly, a weight overload condition, wherein a combined weight of one or more passengers 1306 may be more than pre-defined weight may be determined. Further, an overcrowd situation may be determined if a number of passengers in the passenger pod 1304 are determined to be more than a pre-defined number. Further, the passenger pod 1304 may have heat or air conditioners. Further, various operator type of equipment may be used, such as a radio, joysticks, and doors. Further, the passenger pod 1304 may have windows and other weather protection. Further, the passenger pod 1304 may be able to hold and carry at least 350 lbs. of weight from the UBC.

In an exemplary embodiment, the passenger pod 1304 may be having dimensions such as width 4′ 2″, length 6′ 2″, height 5′.

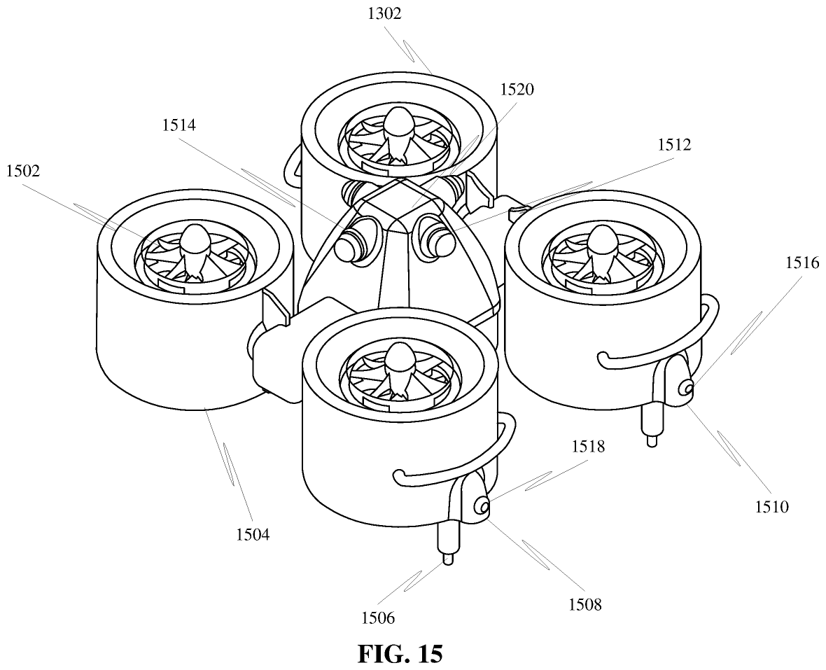

FIG. 15 is an exemplary representation of the drone 1302 of the drone taxi 1300, in accordance with some embodiments. Further, the body of the drone taxi 1300 may be made of carbon fiber, may be 3D printed, and may incorporate a 2 stage turbine engine 1502, a turbine shroud 1504, a positioning feet 1506, downward perimeter cameras 1508-1510, full perimeter cameras 1512-1514, one or more navigation lights 1516-1518, a safety chute 1520 and so on. Further, the 3D printed carbon body of the drone 1302 may house a flight controller, one or more electronics, one or more telemetry tools, one or more sensors, one or more instruments, and so on. Further, the turbine shroud 1504 may be made up of carbon fiber printed material and may be modular and interchangeable, may connect to T-arms by specially designed connectors, and may have handles for easy securing during operation. Further, the enclosed shrouded turbine engines may protect the one or more passengers and passerby using bottom cages that may shield the turbine motor. Further, four motors that may produce 260 lbs. of thrust each, may be used in the drone 1302. Further, the drone 1302 may include one or more positioning feet 1506, equipped with one or more sensors. Further, in an embodiment, the one or more positioning feet 1506 may include fitted suspension devices. Accordingly, the one or more positioning feet 1506 may allow the drone 1302 to take-off and land independently of the passenger pod 1304, and for emergencies such as when the drone 1302 may land unexpectedly. Further, one or more navigation lights 1516-1518 may be included in the drone 1302 and may be used for visual safety and navigation with other crafts and flying objects in the vicinity. Further, one or more downward perimeter cameras 1508-1510 may provide with full telemetry view for smooth landings and take-offs and provide vital information to the remote control station for piloting. Further, additional cameras may be used for positioning and smooth remote control and may provide full view on all sides. Further, the full perimeter cameras 1512-1514 may be powered by LiPo batteries and controlled by a CPU. Further, the full perimeter cameras 1512-1514 may include a telemetry camera for positioning and remote flying full view on 4 sides. Further, the drone 1302 may include using a modular system to allow quick replacements, easy transportation to remote areas, and quick serviceability.

Further, the drones 1302 may pull load instead of pushing the load up to improve efficiency, stability during flight and safety of the drone 1302. Further, the drone 1302 may have an H design in the form of X pattern that may keep engines in line with the center of the drone's body. Further, the H design in the form of X pattern may allow motors or turbines of the drone 1302 to be tilted to provide the required thrust, and for additional maneuverability. Further, the H design allows the drone 1302 to be visible from a distance. Further, modular shrouded engines may be used in the drone 1302 to allow for easy replacement and transportation purposes without any hindrance to service.

In an exemplary embodiment, the two-stage turbine 1502 may have a diameter of 920 mm, a maximum power of 50 kW, a maximum thrust of 118 kg, gross power loading at maximum thrust may be 2.3 g/W, built-in ESC in each motor and so on. In an exemplary embodiment, noise levels generated by the drone 1302 may be 82 decibels. Further, the drone 1302 may weigh 174 lbs, and may have dimensions such as 8′ 4″ width 7′ 5″ length and 4′¼″ height. Further, the 2 stage turbine 1502 may weigh 10 lbs and power may be 50 volts.

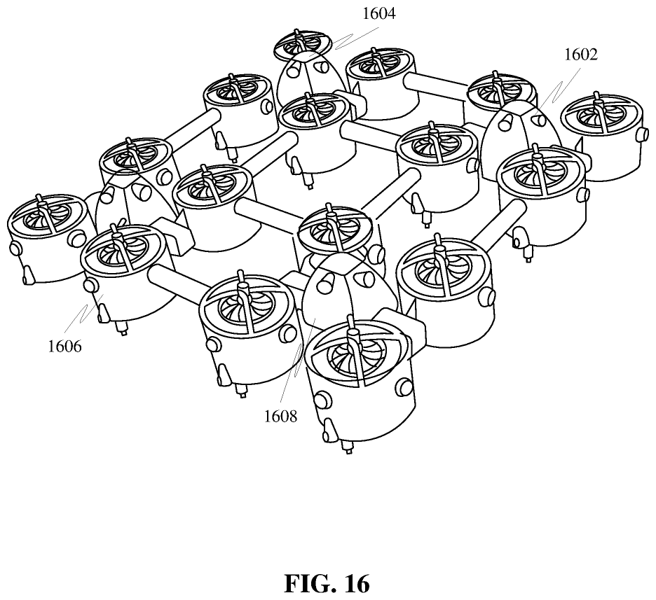

FIG. 16 is an exemplary representation of the swarm technology implemented in a plurality of drone taxis 1602-1608, in accordance with some embodiments. Further, incorporating the swarm technology may allow usage of one drone taxi unit for many uses with other drone taxis of its type. Further, this may enable the plurality of drone taxis 1602-1608 to fly larger payloads, cargo, and in many types of configurations using the one drone taxi unit as many times as needed. Further, with the plurality of drone taxis 1602-1608 incorporating the swarm technology, this may allow to just download, upgrade or install correct electronics or equipment without the need to start over from scratch. Further, it may save much-needed downtime and development resources.

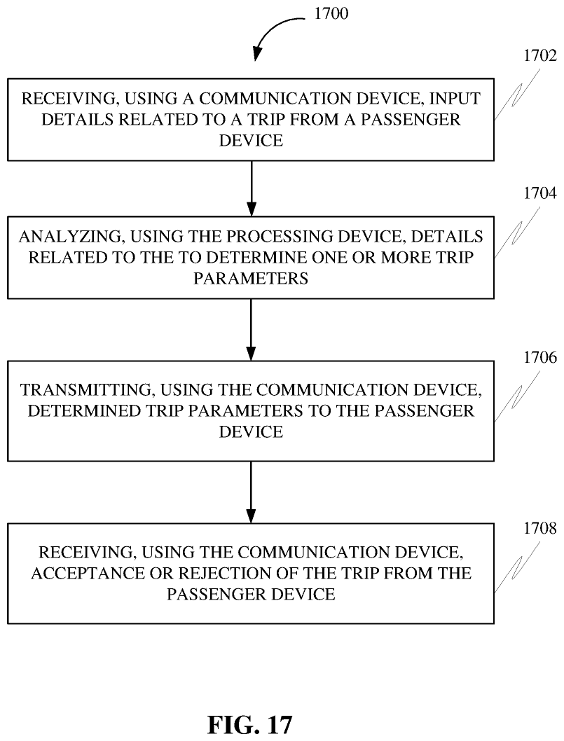

FIG. 17 shows a flowchart of a method 1700 to facilitate the interaction of a passenger and a service provider of a drone taxi service, in accordance with some embodiments. Accordingly, at 1702, the method 1700 may include a step of receiving, using a communication device, input details related to a trip from a passenger device. Further, the passenger device may be operated by a passenger. Further, the passenger may be an individual wishing to avail services of the drone taxi. Further, the input details related to the trip may include details such as the location of the passenger, a number of additional passengers, the drop location of the one or more passengers, and so on. Further, the passenger device may include an electronic device such as a smartphone, tablet, laptop, desktop, and so on. In an instance, the details related to the trip may be received through an input mechanism of a passenger device such as, for example, a desktop computer, laptop computer, a tablet computer, a mobile device, and a wearable device. Further, the passenger device may be configured to communicate with the communication device of a server computer. Accordingly, in an instance, the one or more details related to the trip input through the input mechanism may be transmitted from the passenger device to the server computer.

Further, at 1704, the method 1700 may include a step of analyzing, using the processing device, details related to the to determine one or more trip parameters. Further, the analysis may be done on the input details related to the trip. Further, the analysis may be carried out to determine one or more trip parameters such as a nearest drone taxi dock to the passenger, nearest drone taxi dock to the destination of the passenger, total time duration of trip, cost of trip, and so on. Further, the drone taxi dock may be the place where the drone taxi may be available for one or more riders (or passengers).

Further, at 1706, the method 1700 may include a step of transmitting, using the communication device, determined trip parameters to the passenger device. Further, the determined trip parameters may be transmitted back to the one or more riders on their corresponding rider device. Further, the transmitted trip parameters may include parameters such as nearest drone taxi dock to the one or more riders, nearest drone taxi dock to the one or more riders' destination, the total time duration of a trip, cost of a trip, and so on.

Further, at 1708, the method 1700 may include a step of receiving, using the communication device, acceptance or rejection of the trip from the passenger device. Further, the passenger may indicate a decision either to avail or not to avail services of the drone taxi. Further, if the passenger decides to avail services of the drone taxi, the passenger may be directed to the nearest drone taxi dock.

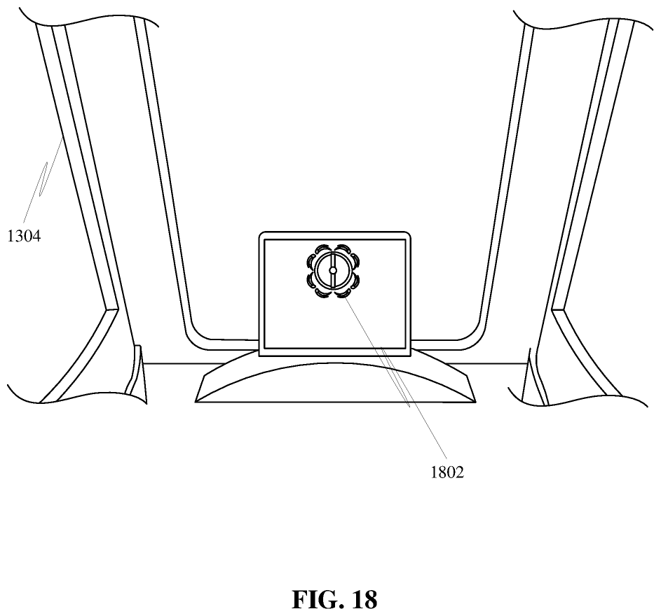

FIG. 18 illustrates an inside view of the passenger pod 1304, in accordance with some embodiments. Accordingly, the inside view 1800 may include a small LED/LCD screen 1802 for the one or more riders to view the one or more trip parameters, for some entertainment like songs or movies, and so on. Further, the one or more rider may view a plurality of breathtaking and interesting views from the drone taxi 1300.

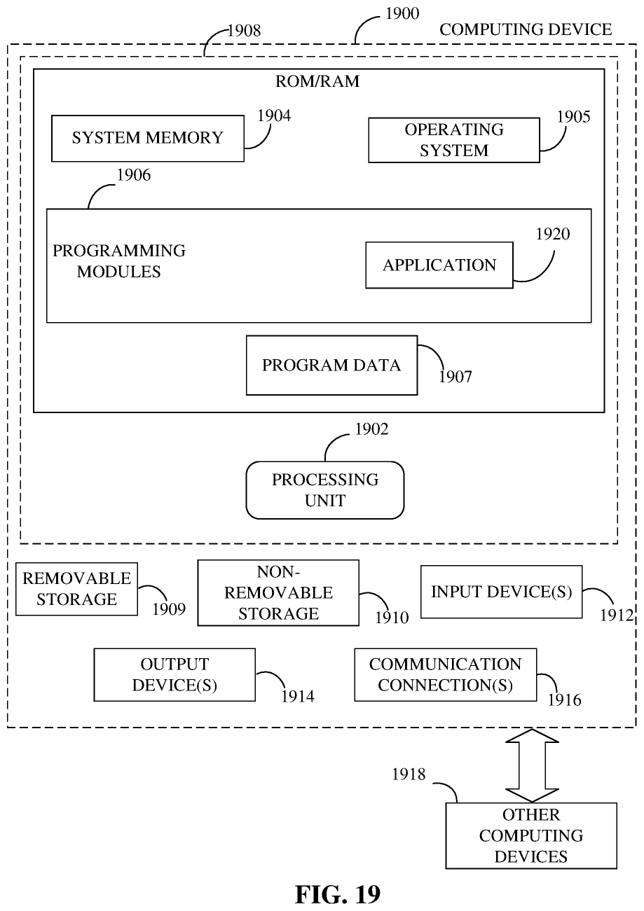

With reference to FIG. 19, a system consistent with an embodiment of the disclosure may include a computing device or cloud service, such as computing device 1900. In a basic configuration, computing device 1900 may include at least one processing unit 1902 and a system memory 1904. Depending on the configuration and type of computing device, system memory 1904 may comprise, but is not limited to, volatile (e.g. random-access memory (RAM)), non-volatile (e.g. read-only memory (ROM)), flash memory, or any combination. System memory 1904 may include operating system 1905, one or more programming modules 1906, and may include a program data 1907. Operating system 1905, for example, may be suitable for controlling computing device 1900's operation. In one embodiment, programming modules 1906 may include image-processing module, machine learning module. Furthermore, embodiments of the disclosure may be practiced in conjunction with a graphics library, other operating systems, or any other application program and is not limited to any particular application or system. This basic configuration is illustrated in FIG. 19 by those components within a dashed line 1908.

Computing device 1900 may have additional features or functionality. For example, computing device 1900 may also include additional data storage devices (removable and/or non-removable) such as, for example, magnetic disks, optical disks, or tape. Such additional storage is illustrated in FIG. 19 by a removable storage 1909 and a non-removable storage 1910. Computer storage media may include volatile and non-volatile, removable and non-removable media implemented in any method or technology for storage of information, such as computer-readable instructions, data structures, program modules, or other data. System memory 1904, removable storage 1909, and non-removable storage 1910 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 1900. Any such computer storage media may be part of device 1900. Computing device 1900 may also have input device(s) 1912 such as a keyboard, a mouse, a pen, a sound input device, a touch input device, a location sensor, a camera, a biometric sensor, etc. Output device(s) 1914 such as a display, speakers, a printer, etc. may also be included. The aforementioned devices are examples and others may be used.

Computing device 1900 may also contain a communication connection 1916 that may allow device 1900 to communicate with other computing devices 1918, such as over a network in a distributed computing environment, for example, an intranet or the Internet. Communication connection 1916 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory 1904, including operating system 1905. While executing on processing unit 1902, programming modules 1906 (e.g., application 1920 such as a media player) may perform processes including, for example, one or more stages of methods, algorithms, systems, applications, servers, databases as described above. The aforementioned process is an example, and processing unit 1902 may perform other processes.

Generally, consistent with embodiments of the disclosure, program modules may include routines, programs, components, data structures, and other types of structures that may perform particular tasks or that may implement particular abstract data types. Moreover, embodiments of the disclosure may be practiced with other computer system configurations, including hand-held devices, general purpose graphics processor-based systems, multiprocessor systems, microprocessor-based or programmable consumer electronics, application specific integrated circuit-based electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general-purpose computer or in any other circuits or systems.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random-access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, solid state storage (e.g., USB drive), or a CD-ROM, a carrier wave from the Internet, or other forms of RAM or ROM. Further, the disclosed methods' stages may be modified in any manner, including by reordering stages and/or inserting or deleting stages, without departing from the disclosure.

Although the present disclosure has been explained in relation to its preferred embodiment, it is to be understood that many other possible modifications and variations can be made without departing from the spirit and scope of the disclosure.

The following is claimed:

1. A flying taxi for facilitating the transportation of payloads, the flying taxi comprising:
at least one pod configured to receive at least one payload, wherein the at least one pod comprises at least one weight sensor disposed on the at least one pod, wherein the at least one weight sensor is configured to generate at least one weight data corresponding to a weight of a payload of the at least one payload;
a processing device communicatively coupled with the at least one weight sensor, wherein the processing device is configured for:
analyzing the at least one weight data; and
generating at least one notification based on the analyzing;
a presentation device communicatively coupled with the processing device, wherein the presentation device is configured for presenting the at least one notification; and
at least one aerial vehicle detachably couplable with the at least one pod using at least one coupling mechanism, wherein the at least one aerial vehicle comprises at least one propeller assembly disposed on an aerial vehicle of the at least one aerial vehicle, wherein the at least one propeller assembly is configured for propelling the flying taxi.

2. The flying taxi of claim 1 further comprising at least one airfoil assembly disposed on at least one of each pod and each aerial vehicle, wherein the at least one airfoil assembly generates at least one resistive force on the flying taxi in opposition to a gravitational force on the flying taxi during a descent of the flying taxi.

3. The flying taxi of claim 2, wherein the at least one airfoil assembly is configured in an un-deployed configuration and at least one deployed configuration, wherein the at least one airfoil assembly is configured to transition between the un-deployed configuration and the at least one deployed configuration, wherein the at least one airfoil assembly generates the at least one resistive force in the at least one deployed configuration, wherein the at least one airfoil assembly does not generate the at least one resistive force in the un-deployed configuration.

4. The flying taxi of claim 3 further comprising:
at least one airfoil sensor disposed on the at least one of the each aerial vehicle and the each pod, wherein the at least one airfoil sensor is configured to generate at least one airfoil sensor data corresponds to at least one state of the at least one of the each aerial vehicle and the each pod in relation to at least one surface, wherein the processing device communicatively coupled with the at least one airfoil sensor, wherein the processing device is configured for:
analyzing the at least one airfoil sensor data; and
generating at least one airfoil control command; and
at least one airfoil actuator communicatively coupled to the processing device, wherein the at least one airfoil actuator is operationally coupled with the at least one airfoil assembly, wherein the at least one airfoil actuator is configured to transition the at least one airfoil assembly between the un-deployed configuration and the at least one deployed configuration based on the at least one airfoil control command.

5. The flying taxi of claim 1, wherein the at least one coupling mechanism comprises a first part disposed on the at least one aerial vehicle and a second part disposed on the at least one pod, wherein the first part and the second part is detachably coupled facilitating the at least one aerial vehicle to be detachably couplable with the at least one pod.

6. The flying taxi of claim 1 further comprising at least one actuator operationally coupled with the at least one aerial vehicle, wherein the at least one actuator is configured to couple the at least one aerial vehicle with the at least one pod and decoupled the at least one aerial vehicle from the at least one pod.

7. The flying taxi of claim 6, wherein the at least one actuator comprises a handle, wherein the handle is configured to receive at least one external force manually, wherein the handle is configured to transition between a lock position and an unlock position, wherein the at least one aerial vehicle is coupled with the at least one pod in the lock position and the at least one aerial vehicle is decoupled from the at least one pod in the unlock position.

8. The flying taxi of claim 1, wherein the at least one pod comprises at least one pod foot, wherein the at least one pod foot is configured in at least one pod foot configuration, wherein the at least one pod foot configuration facilitates placing of the at least one pod on at least one surface in at least one pod orientation in relation to the at least one surface.

9. The flying taxi of claim 1, wherein the at least one aerial vehicle comprises at least one vehicle positioning foot, wherein the at least one vehicle positioning foot facilitates placing of the at least one aerial vehicle coupled with the at least one pod on at least one surface and the at least one aerial vehicle decoupled from the at least one pod on the at least one surface.

10. The flying taxi of claim 9, wherein the at least one vehicle positioning foot is configured in a retracted configuration and at least one extended configuration, wherein the at least one vehicle positioning foot is configured to transition between the retracted configuration and the at least one extended configuration, wherein the at least one extended configuration facilitates the placing of the at least one aerial vehicle on the at least one surface and the retracted configuration does not facilitate the placing of the at least one aerial vehicle on the at least one surface.

11. The flying taxi of claim 10 further comprising:
at least one vehicle sensor disposed on the at least one aerial vehicle, wherein the at least one vehicle sensor is configured to generate at least one vehicle sensor data, wherein the at least one vehicle sensor data corresponds to at least one state of the at least one aerial vehicle in relation to the at least one surface, wherein the processing device communicatively coupled with the at least one vehicle sensor, wherein the processing device is configured for:
analyzing the at least one vehicle sensor data; and
generating at least one vehicle command based on the analyzing; and
at least one vehicle actuator communicatively coupled to the processing device, wherein the at least one vehicle actuator is operationally coupled with the at least one vehicle positioning foot, wherein the at least one vehicle actuator is configured for transitioning the at least one vehicle positioning foot between the retracted configuration and the at least one extended configuration based on the at least one vehicle command.

12. The flying vehicle of claim 1, wherein the at least one propeller assembly is associated with at least one engaged state and a disengaged state, wherein the at least one propeller assembly propels the flying taxi in the at least one engaged state, wherein the at least one propeller assembly does not propel the flying taxi in the disengaged state, wherein the at least one propeller assembly is configured to transition between the at least one engaged state and the disengaged state.

13. The flying vehicle of claim 12, wherein the processing device is further configured for generating at least one propeller control command based on the analyzing of the at least one weight data, wherein the flying vehicle further comprising at least one propeller actuator communicatively coupled with the processing device, wherein the at least one propeller actuator is operationally coupled with the at least one propeller assembly, wherein the at least one propeller actuator configured to transition the at least one propeller assembly between the at least one engaged state and the disengaged state based on the at least one propeller control command.

14. A flying taxi for facilitating the transportation of payloads, the flying taxi comprising:
at least one pod configured to receive at least one payload, wherein the at least one pod comprises at least one weight sensor disposed on the at least one pod, wherein the at least one weight sensor is configured to generate at least one weight data corresponding to a weight of a payload of the at least one payload;
a processing device communicatively coupled with the at least one weight sensor, wherein the processing device is configured for:
analyzing the at least one weight data; and
generating at least one notification based on the analyzing;
a presentation device communicatively coupled with the processing device, wherein the presentation device is configured for presenting the at least one notification;
at least one aerial vehicle detachably couplable with the at least one pod using at least one coupling mechanism, wherein the at least one aerial vehicle comprises at least one propeller assembly disposed on an aerial vehicle of the at least one aerial vehicle, wherein the at least one propeller assembly is configured for propelling the flying taxi; and
at least one airfoil assembly disposed on at least one of each pod and each aerial vehicle, wherein the at least one airfoil assembly generates at least one resistive force on the flying taxi in opposition to a gravitational force on the flying taxi during a descent of the flying taxi.

15. The flying taxi of claim 14, wherein the at least one airfoil assembly is configured in an un-deployed configuration and at least one deployed configuration, wherein the at least one airfoil assembly is configured to transition between the un-deployed configuration and the at least one deployed configuration, wherein the at least one airfoil assembly generates the at least one resistive force in the at least one deployed configuration, wherein the at least one airfoil assembly does not generate the at least one resistive force in the un-deployed configuration.

16. The flying taxi of claim 14, wherein the at least one coupling mechanism comprises a first part disposed on the at least one aerial vehicle and a second part disposed on the at least one pod, wherein the first part and the second part is detachably coupled facilitating the at least one aerial vehicle to be detachably couplable with the at least one pod.

17. The flying taxi of claim 14 further comprising at least one actuator operationally coupled with the at least one aerial vehicle, wherein the at least one actuator is configured to couple the at least one aerial vehicle with the at least one pod and decoupled the at least one aerial vehicle from the at least one pod.

18. The flying taxi of claim 17, wherein the at least one actuator comprises a handle, wherein the handle is configured to receive at least one external force manually, wherein the handle is configured to transition between a lock position and an unlock position, wherein the at least one aerial vehicle is coupled with the at least one pod in the lock position and the at least one aerial vehicle is decoupled from the at least one pod in the unlock position.

19. The flying taxi of claim 14, wherein the at least one pod comprises at least one pod foot, wherein the at least one pod foot is configured in at least one pod foot configuration, wherein the at least one pod foot configuration facilitates placing of the at least one pod on at least one surface in at least one pod orientation in relation to the at least one surface.

20. The flying taxi of claim 14, wherein the at least one aerial vehicle comprises at least one vehicle positioning foot, wherein the at least one vehicle positioning foot facilitates placing of the at least one aerial vehicle coupled with the at least one pod on at least one surface and the at least one aerial vehicle decoupled from the at least one pod on the at least one surface.
